(19) United States
(12) Patent Application Publication
(10) Pub. No.: US 2007/0179843 A1
(43) Pub. Date: Aug. 2, 2007

(54) Information engine and associated method of delivering targeted metrics

(75) Inventors: Andrew Eichenbaum, San Francisco, CA (US); Sukesh Garg, San Francisco, CA (US); Pramila Mullan, San Francisco, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/345,383

(22) Filed: Feb. 2, 2006

(51) Int. Cl. G06Q 30/00

(52) U.S. Cl. 705/14

(57) ABSTRACT

A wireless mobile computing device is provided for receiving and transmitting data. A wireless interface is configured to capture product parameters. The parameters function to at least identify the product with respect to a repository of information operably linked to the mobile computing device. A transceiving unit is configured to provide the captured product parameters to the repository of information, and, to provide location parameters of the mobile computing device to a market locator system. In return, the transceiving unit receives product information from the repository of information which corresponds to the product parameters. The product information also corresponds to a location of the mobile computing device identified by the market locator system. A user interface is configured to provide targeted product information to the user.

### BACKGROUND OF THE INVENTION

The present invention relates to an information engine providing, for example, targeted commerce metrics to a consumer in the marketplace, and, more specifically, to a system for disseminating market metrics to a user relative to a product query generated at a determined user location.

The “background” description provided herein is for the purpose of generally presenting the context of the invention. Work of the presently named inventors, to the extent it is described in this background section, as well as aspects of the description which may not otherwise qualify as prior art at the time of filing, are neither expressly or impliedly admitted as prior art against the present invention.

The advancement of wireless communication has resulted in an expansion of content availability to portable devices such as cell phones, PDAs and the like. As such, service providers are increasingly embracing bandwidth availability to deliver content to mobile users in the form of audio/video files, World Wide Web Access, email and the like. In this manner, a mobile user is able to secure much the same content as if he/she were at a home location utilizing a traditional desktop computing environment.

In making purchasing decisions, many consumers have now become accustomed to researching price, quantity, quality and other traditional commercial considerations via the Internet. For example, prior to embarking on a shopping trip, it is not uncommon for users to identify pricing/sales information via Internet storefronts. In some cases, the user may opt to purchase directly from the storefront, or, opt to use the information as a reference during a subsequent shopping trip.

Presently, some mobile service providers have introduced a feature to their mobile devices by which consumers can access information regarding a potential purchase at a merchant location. For example, Accenture's “Pocket Bargain Finder” and “Shopper's Eye” are general comparison shopping guides for a mobile phone. This feature typically involves the consumer utilizing their mobile device to read a barcode or recognize an image of a product. To this end, mobile devices are provided with an appropriate video interface of the mobile device for capturing the product information. Such mobile camera interfaces are marketed by Scanbuy, M-Ken, Mediastick, and NeoMedia. Once read, Internet links can be leveraged such that the information captured by the mobile device may be provided to an operably linked product server.

Yet, the product information available in these configurations is limited to general descriptions and links to manufacturer websites. There is no provision in these systems to provide marketing/pricing metrics which are based upon a market condition or user location; for example, where consumers want to compare product availability and cost in the particular market area.

Accordingly, there is a need for a mobile device and associated system for disseminating targeted market metrics and associated information to a user relative to a product so that the user can make informed purchase decisions.

### SUMMARY OF THE INVENTION

The present invention is directed to a wireless mobile computing device for receiving and transmitting data. A wireless interface is operative to capture product parameters. The product parameters function to at least identify the product with respect to a repository of information operably linked to the mobile computing device. A transceiving unit provides the captured product parameters to the repository of information, and, provides location parameters of the mobile computing device to a market locator system. In return, the transceiving unit receives product information from the repository of information. The product information corresponds to the product parameters and is selected in accordance with a location of the mobile computing device identified by the market locator system. A user interface of the mobile device provides targeted product information to the user.

In a further aspect of the invention, a wireless communication device for receiving and transmitting communications is provided. An interface of the device is operative to receive product parameters. The product parameters function to at least identify the product. A transceiving unit of the device provides location parameters of the mobile computing device to a market locator system. In return, the transceiving unit receives a location of the mobile computing device from the market locator system. An application program cooperatively receives the product parameters of the interface and the identified location. The application program communicates with a predetermined server operably linked to the communication device to provide the identified market location and product parameters to the server. In return, the application program receives information pertaining to the product which is dictated, in part, by the identified location. A user interface of the device provides targeted product information to the user.

In still a further aspect of the invention, a system for providing targeted product information to a consumer is provided. A mobile device captures product parameters, the parameters function to at least identify a product. The mobile device also captures location parameters of the mobile device. The location parameters are provided to a service for identifying a location of the mobile device. A server receives the product parameters and the identified location parameters from the mobile device. A repository of information receives queries of the server based upon the product parameters and identified location. The repository of information selects product information in response to the query in accordance with the identified location. The selected product information is provided to the server in response to the query. In this way, the targeted product information is provided to the mobile device from the server for use by the consumer.

In yet another aspect of the invention, an application program is provided for execution at a mobile device for receiving targeted information metrics. The application program functions to capture product parameters via the mobile device. The parameters function to at least identify the product with respect to a repository of information operably linked to the mobile computing device. The program provides the captured product parameters to the repository of information and provides location parameters of the mobile computing device to a market locator system. The program is operative to receive product information at the mobile device from the repository of information, the product information corresponding to the product parameters and, selected in accordance with a location of the mobile device identified by the market locator system. The program delivers the targeted product information to a display of the mobile device.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 is a high level block diagram of a mobile device in accordance with an exemplary embodiment of the invention;

FIG. 2 is a high level architectural diagram of the network middleware in accordance with an exemplary embodiment of the invention;

FIG. 3 is a flowchart showing the processing function of the middleware of FIG. 2; and,

FIG. 4 is a high level architectural diagram of network middleware of an alternative embodiment of the invention.

### DETAILED DESCRIPTION OF THE INVENTION

Certain terminology used in the following description is for convenience only and is not limiting. The term “location” as used herein generally embraces a market of a queried product of a merchant, which includes geographic considerations, but is not limited thereto. Likewise, location is not to be construed as limited to a specific merchant, store location, although it may be if so desired. The “market,” as used herein, will vary depending upon application affected by a variety of parameters such as, geography, regional demographics, supply/demand concerns, targeted product promotions and the like. In the drawings, the same reference numerals are used for designating the same elements throughout the several figures.

The present invention provides access to market significant content through the use of a mobile device. In the exemplary embodiment, a user of a mobile device would input a query into suitable device such as a cellular phone. The query may be directly entered as text, and/or be captured via a product signature such as expressed by a barcode, RFID signal and/or NFC signal. Upon the transmission of the query, the mobile device may relay a location of the device by a positioning mechanism of the device, or, query the carrier/provider for its location based upon an automatic positioning system (e.g. cell phone tower location or GPS). The mobile device may then send the query and location to a content server. The content server is operative to respond with relevant location specific metrics that are indicative of the location (i.e., market) of the mobile device user.

I. Mobile Device

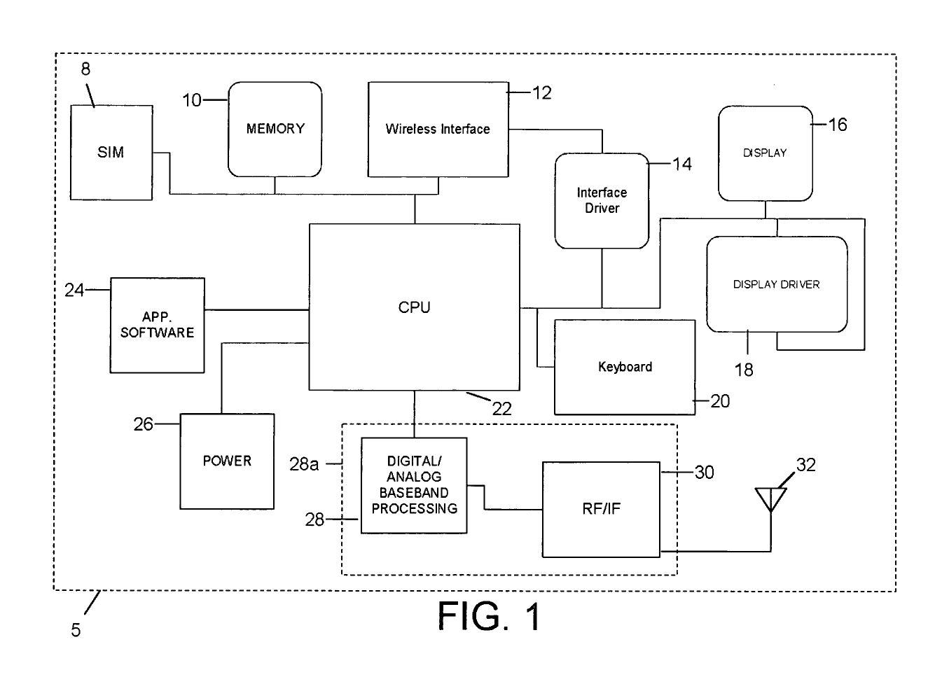

Referring now more specifically to FIG. 1, an exemplary cellular mobile device 5 of the invention is shown. Those skilled in the art will recognize that the invention embraces a range of mobile devices and hand held computing devices. Such devices may embody generic computing platforms such as a laptop computer, or, may be more application specific devices such as portable media players, satellite receivers, portable gaming devices, and the like.

The exemplary embodiment of FIG. 1 is a cellular phone having a Subscriber Identity Module (SIM) 8, Memory 10, wireless interface 12, interface driver 14, display 16, display driver 18, keyboard 20, CPU 22, application software 24, power source 26, digital/analog baseband processor 28, RF/IF unit 30 (processor 28 and unit 30 generally referred to as transceiver 28a) and antenna 32. Of course, mobile device 5 may leverage a variety of wireless communication schemes, including GSM, CDMA, TDMA, AMPS, 3GPP, etc. Likewise, non-cellular technologies such as Wi-Fi, EV-DO, wireless USB, Bluetooth®, Wi-Bro or Wimax are also within the scope of the exemplary mobile device 5. Less desirably, the mobile device 5 may be directly cabled to a host device (not shown).

The exemplary mobile device 5 employs a removable SIM 8 for storing user specific data such as contact data, and user preferences such that this data may be transferred to other mobile devices 5. Likewise, SIM 8 stores all the connection data and identification numbers to access a particular wireless service provider. Further, the exemplary SIM 8 includes behavior data, such as past product queries, purchase records and shopping history in accordance with the invention as described further below. This data may be provided during subsequent queries in accordance with the invention to qualify the mobile user for coupon and or discounts. In some embodiments, this feature may be disabled to secure user privacy, or, enabled, in exchange for access to the information engine. Alternatively, memory 10 may store this information, however, such a configuration would undermine the ability to readily transport the data from device to device.

Memory 10 is provided for standard device features, including I/O capabilities and supporting a software platform in cooperation with CPU 22. The description of these features is omitted for brevity, the detailed operation/description of which is well known to those skilled in the art. The exemplary mobile device 5 may utilize the Symbian®, Windows CE®, LINUX, PA1M or other known operating systems. Likewise, non-mobile platforms such as Microsoft Windows Vista®, UNIX, MAC OS and the like may be utilized.

A display 16 is provided for presenting a graphical user interface (GUI) to the user of exemplary mobile device 5. The exemplary display 16 is an LCD display driven by display driver 18 in conjunction with an operating system of the mobile device 5. The exemplary display 16 may incorporate touch-screen functionality actuated by a stylus or user directly.

Exemplary keyboard 20 is provided for receiving input from the user of mobile device 5 in the usual manner. Interface driver 14 is provided to operate in conjunction with an operating system of mobile device 5 to drive keyboard 20 and wireless interface 12.

The exemplary wireless interface 12, may employ any of a number of sensor types to capture product parameters. Wireless interface 12 may employ a CCD/CMOS video camera for capturing a signature of a product. In alternative embodiments, a Near Field Communication (NFC) sensor, barcode scanner or Radio Frequency ID (RFID) sensor may be employed. Wireless interface 12 may be used in conjunction with keyboard 20 to augment or modify captured product parameters. Those skilled in the art will recognize that appropriate signal conditioning and processing circuitry for such alternative embodiments is well known and omitted from FIG. 1 for the purpose of brevity.

The CPU 22, for example, may be embodied as software, middleware or firmware. Likewise, CPU 22 may be embodied as programmable logic, an Application Specific Integrated Circuit (ASIC), microcontroller, or microprocessor or general purpose computer. The CPU includes an instruction set for operating the communication features of mobile device 5. Such communication features are operated in conjunction with baseband processing unit 28 RF/IF unit 30 and antenna 32. CPU 22 also provides a platform for application software 24.

Transceiving unit 28a includes baseband processing unit 28 and RFIIF unit 30 which cooperatively function with CPU 22 to provided bidirectional communication with mobile device 5 and operably linked devices in accordance with a wireless communication scheme. The encoding, encryption, and modulation functions of transceiving unit 28a operate to provide voice and data communication as known to those skilled in the art.

Exemplary application software 24 may include a web browser which provides a Graphical User Interface (GUI). The GUI presents a computer environment that displays, or facilitates the display of on-screen options in the form of icons, menus, radio buttons, and the like, such as typically presented in a Windows-based operating system. Such browsers may include the Mozilla Minimo®, Opera® and Thunderhawk® mobile browsers. Of course, in a laptop configuration, Microsoft Internet Explorer®, Netscape Navigator®, Firebox the like may be utilized. Exemplary application software 24 includes software for recognizing the capture of product information via wireless interface 12. In the exemplary embodiment, the browsing software may employ a plug-in to perform this function. The plug-in code registers itself and monitors events of the wireless interface 12. The plug-in may or may not respond to the event depending upon user preferences stored in SIM 8. In particular, the plug-in may initiate the transceiving circuitry, or other application software of the mobile device 5 in response to the capture of product information via wireless interface 12. In an alternative embodiment, dedicated application software is provided for receiving the product information indicia from the wireless interface 12. This software may communicate, via the transceiving circuitry of mobile device 5, without use of the browser to communicate with an operably linked server.

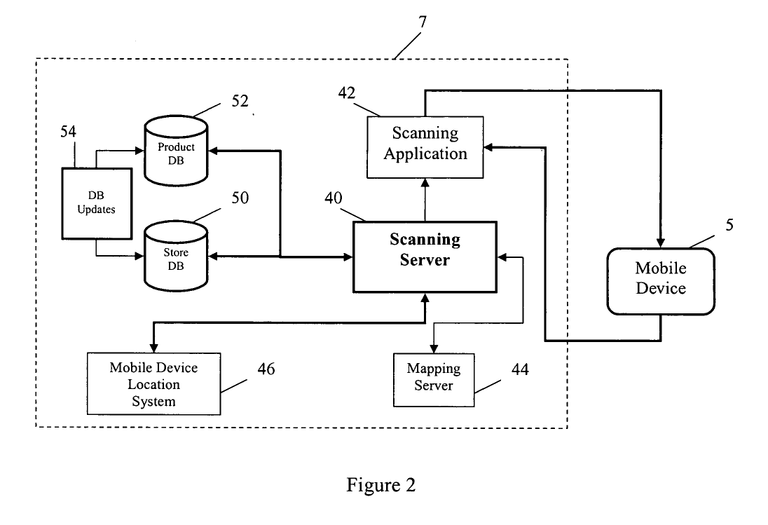

Exemplary application software 24, includes software for providing location parameters of the mobile device. The location may be determined through a local Global Positioning System (GPS) of the mobile device 5 (not shown), or, may function to query a cellular or GPS location system through transceiving circuitry of mobile device 5. As above, the transceiving unit 28a would be actuated to provide location parameters to a locator system 46 as shown in FIG. 2.

The exemplary power source 26 is provided to power the circuitry of mobile device 5. In the exemplary embodiment, the power source 26 is a rechargeable battery. II. Information Engine

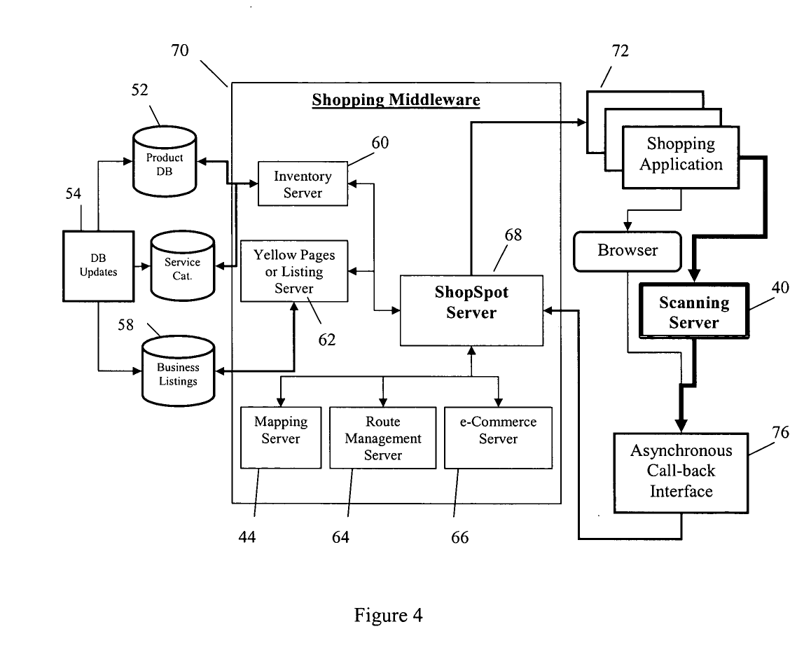

Referring now to FIG. 2, a high level architectural diagram of the information engine 7 middleware in accordance with an exemplary embodiment of the invention is shown. Here, the mobile device 5 interfaces a Scanning Server 40 via an Application layer embodied by application software 42. The Scanning Server 40 then communicates with product database 52, store database 50, mobile device location system 46, and a mapping server 44. Any of the above mentioned servers can be disabled in a particular query due to input from the mobile device 5 or information from outside systems (see FIG. 4).

The mobile device 5, mobile location System 46 and Scanning Server 40 are operably linked via a telecommunication network in accordance with a communication scheme of the mobile device 5.

In the exemplary embodiment, the telecommunication network includes access to a global communications network, commonly referred to as the Internet. The components of information engine 7 communicate via telecommunication network through a protocol of the TCP/IP stack. In the exemplary embodiment, the components utilize the hyper text transfer protocol (HTTP). The discussion of routine HTTP protocol handshaking and DNS query processing is omitted here for sake of brevity. In the exemplary embodiment, transmission between the components of the information engine 7 is encrypted through Secure Shell (SSH), or, provided from the mobile device 5 as data of a Virtual Private Network (VPN) configuration employing Internet Protocol Security (IPSec), layer Two Tunneling Protocol (L2TP) or the like to secure user privacy. Those skilled in the art recognize that while an exemplary embodiment is defined as being used with the Internet, the present invention is equally applicable to any local area network (LAN) or wide area network (WAN) configuration whether land-based or wireless in form. In an alternative embodiment, the information engine 7 described herein may be interfaced with a stand-alone kiosk of a merchant location for access by multiple users, in addition to mobile device 5.

In the exemplary embodiment Scanning Server 40 functions as a web front end to provide a graphical user interface (GUI). The components of Scanning Server 40 employ a windows based operating system; however, alternative operating systems may include, but are not limited to, Unix, Solaris, Linux. Thus, the Scanning server 40 provides the front end for connection to the network such as the Internet to operably link to mobile device 5. In the exemplary embodiment, the Scanning server 40 employs application software 42, such as Microsoft® Windows 2003 Server, Active Directory, and FTP. Likewise, MS SQL is employed for interfacing databases 50 and 52. The exemplary graphical user interface, hereafter “website” of Scanning Server 40 is directly linked to databases 50 and 52, providing real-time database querying.

In the exemplary embodiment, Scanning Server 40 runs the commercial server application Microsoft® NET operating system as the interface to a telecommunications network for facilitating communication through the hyper text transfer protocol (HTTP) (HTTPS) for cooperatively interacting with exemplary mobile device 5, which employs a graphical user interface (i.e., web browser). Static web page documents or web content of Scanning Server 40 comprise the structural portion of a viewable website, which may include query templates, resultant data pages, site navigation features, and supporting information. The Internet connection provides graphical ideographic, automatic, and text-based querying. Product information is in this manner, dynamically retrieved, assembled, and formatted, in response to product information queries of mobile device 5.

The exemplary graphical user interfaces described herein include known static HTTP-based components, such as hyper text mark-up language (HTML) as well as dynamic components, including server side executable components, such as Java, PERL, Active-X, common gateway interface scripts (CGI), and the like. Those skilled in the art recognize that a variety of protocols, programming structures and interface options may be utilized for conveying web-based information between a central location and a remote location and that the present invention is not limited to the examples discussed herein.

In this way, the Scanning Server 40 serves as an information engine in conjunction with databases 52 and 50. Information of these databases may be selected and or filtered in accordance with location data of location system 46 as detailed herein. Thus, the commercial server application manages incoming requests and database and location system process initiations.

The web interface of Scanning Server 40 provides an easily accessible querying and communication tool to mobile device 5. Queries are made from Scanning Server 40 to location system 46, and database 52 (product database) and database 50 (store database), which then, in cooperation with Scanning server 40 return customized data back to the web browser of mobile device 5 over the telecommunications network. In this way, exemplary Scanning Server 40 functions as the primary data dissemination tool for operators of mobile devices 5.

Product information queries are passed from Scanning Server 40 as product parameters captured from mobile device 5. These queries are provided to databases 50 and 52 as Asynchronous Common Gateway Interface (ACGI) events from the commercial server application to a database management system. The database management system and mechanism for updating the databases 50 and 52 is performed by database update module 54. These databases may be maintained by operators of the Scanning server or separately provided by a third party vendor (See FIG. 4). Scanning Server 40 then retrieves the relevant data, formats it into the proper hyper text mark-up language (HTML) file, for uploading to the GUI of mobile devices 5. In the exemplary embodiment, the location of the mobile device 5 is determined by Scanning Server 40 in order to determine the relevant product information from databases 50 and 52. Preferably, this determination is done before querying the databases 50 and 52 to reduce the universe of data transferred from the databases. Those skilled in the art will recognize that while databases 50 and 52 while separately depicted in the drawings, this separate depiction is provided for illustrating functionality only, and, does not limit the databases from being physically integrated as a single repository.

As mentioned above, the mobile device location system 46 may be a GPS based service or location service which is related to the cellular location of the mobile device 5. In such an embodiment control signals levels of mobile device may be compared relative to cells of the cellular network to determine the location of the mobile device. Likewise, identifiers may be communicated directly to the mobile device location system such as in accordance with Federal Communication Commission (FCC) E911 protocols. Thus, the mobile locator system either calculates or indexes an location of the mobile device and provides location information to Scanning Server 40. In alternative embodiments in which the mobile device 5 includes GPS capability, location system 46 is omitted and location is provided directly to Scanning Server 40.

Scanning Server 40, upon receiving location information of mobile device location system 46, filters where necessary, and processes data provided from data base 52 and 50 to obtain market specific data relative to the product query of the mobile device 5 and a calculated position. In embodiments where history data is transmitted from SIM 5 along with the current product parameters, Scanning Server 40 may identify discount and/or coupon information may to be provided to the mobile device 5.

The mapping server 44 functions in conjunction with the received location information to provide a displayable map to the GUI of Scanning Server 40. In an exemplary embodiment, mapping server 44 may be a known mapping service such as Mapquest®, Google Earth®, or Yahoo® mapping services integrated as a portion of the data presented to the mobile device 5.

Any process descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

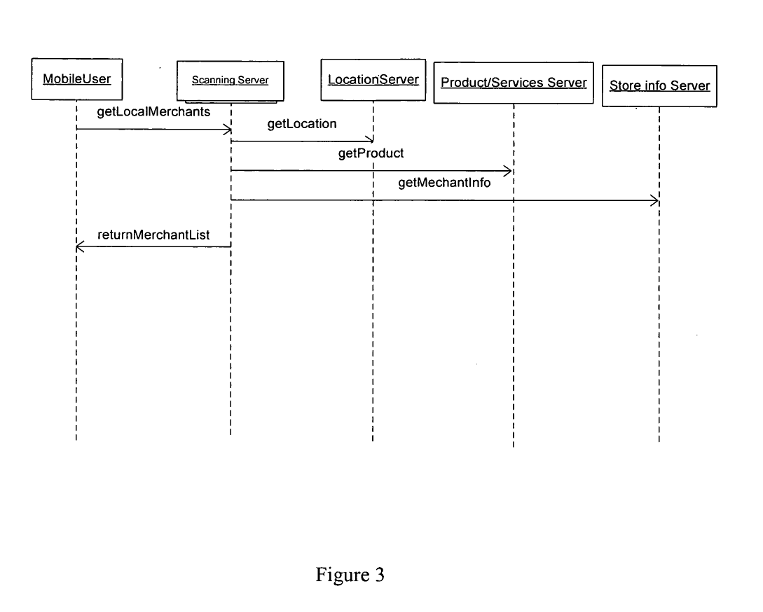

An exemplary communication flow in accordance with the present invention is shown in FIG. 3. An exemplary product information query is now outlined utilizing the information engine 7. A user of a mobile device 5 patronizes a merchant location and is interested in obtaining information about a certain product. The user utilizes mobile device 5 to capture product parameters of the product. The product parameters are captured via a barcode scan, detected NFC, or RFID signal through wireless interface 12 of the mobile device 5. Likewise, the user may augment or modify a query with these product parameters through keyboard 20 and or a voice command. The mobile device then transmits these product parameters and a location parameter which is used to identify the location of the mobile device 5 to the Scanning Server 40, as shown as “getLocalMerchants.” The Scanning server then queries the mobile device's provider (or other source like GPS) for its location as shown as “getLocation.” The Scanning server then queries the product database for info on the queried product including stores that carry the product as shown as “getProduct.” The product and location info (from above) is then fed into the online store database as shown as “getMerchantInfo.” The closest stores corresponding to a determined market are returned to the Scanning server as shown as “returnMerchantList.” The Scanning server returns the product and location info requested to the user (properly formatted for the mobile device as a web page or as a Short Message Service (SMS)). The product information about the product includes where the product can be found in the local market area, prices at the local stores, reviews of the local stores, coupon data, discount information, comparison pricing, mapping data illustrating other merchants carrying the product, etc.

Furthermore, in an alternative embodiment, a user of the mobile device 5 may desire information about a certain product where Scanning server 40 is interfaced with a pre-existing product and store search engine. As shown in FIG. 4. In FIG. 4, Shopping 70 is a system that provides shopping route mapping based upon desired products and services. Shopping Middleware 70 includes a Shopping Server 68, Inventory Server 60, Directory or Listing Server 62, e-commerce server 66, route management server 64 and mapping server 44. The Shopping system 70 is operably linked to databases 52, 56 and 58. Databases 52, 56 and 58 are managed and updated by updating and management unit 54.

In this embodiment, Shopping Server 68 functions to return the product information of a query of mobile device 5. The Shopping Server 68 manages the accessing of databases and location services to return an integrated response to Scanning Server 40. The Shopping middleware 70, including servers 60, 62, and 64 already contain integrated product and store location information. In this way, the Scanning server 40 then only has to find the location of the mobile device 5 and then send the location and product parameters to the Shopping server 68 (bypassing the interfacing and management of databases 50 and 52 of FIG. 2).

Obviously, readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

What is claimed is:

1. A wireless mobile computing device for receiving and transmitting data, comprising:
a wireless interface operative to capture product parameters, the parameters functioning to at least identify the product with respect to a repository of information operably linked to the mobile computing device;
a transceiving unit configured to provide the captured product parameters to the repository of information, and, to provide location parameters of the mobile computing device to a market locator system, in return, the transceiving unit receiving product information from the repository of information, the product information corresponding to the product parameters and being selected in accordance with a location of the mobile computing device identified by the market locator system, and
user interface configured to provide targeted product information to the user.

2. The wireless mobile computing device of claim 1, wherein the wireless interface is a barcode scanner.

3. The wireless mobile computing device of claim 1, wherein the wireless interface is a video camera.

4. The wireless mobile computing device of claim 1, wherein the wireless interface is a Near Field Communication (NFC) device.

5. The wireless mobile computing device of claim 1, further comprising:
a Global Positioning System (GPS) transceiver configured to relay the location parameters to the market locator system.

6. The wireless mobile computing device of claim 1, wherein, the location parameters are signals identifying a location relative to a cell of a cellular network.

7. The wireless mobile computing device of claim 1, wherein the product parameters are provided to a server which forwards the product parameters and identified location to the repository of information.

8. The wireless mobile computing device of claim 7, wherein the server receives the identified location from the market locator system.

9. The wireless mobile computing device of claim 1, wherein the targeted product information includes information pertaining to merchants in the area of the mobile computing device.

10. The wireless mobile computing device of claim 1, further comprising:
a memory configured to store history information, the history information being past targeted product information delivered to the wireless mobile computing device.

11. The wireless communication device of claim 1, wherein the user interface is a display which provides a map to the user for identifying area merchants selling the targeted product; and,
the map includes Hyper Text Mark Up Language (HTML) links to third party reviews of the targeted product and coupon information.

12. The wireless communication device of claim 1, wherein coupon information is delivered to the mobile device for transmission from the wireless interface upon purchase of the targeted product.

13. The wireless communication device of claim 12, wherein the coupon information is specific to a merchant location.

14. A system for providing targeted product information to a consumer, comprising:
a mobile device configured to capture product parameters, the parameters functioning to at least identify a product, and configured to capture location parameters of the mobile device, the location parameters being provided to a service for identifying a location of the mobile device;
a server configured to receive the product parameters and the identified location parameters from the mobile device;
a repository of information configured to receive queries of the server based upon the product parameters and identified location, the repository of information selecting product information in response to the query in accordance with the identified location, the selected product information being provided to the server in response to the query,
wherein targeted product information is provided to the mobile device from the server for use by the consumer.

15. A method of receiving targeted information metrics, comprising:
capturing product parameters via a mobile device, the parameters functioning to at least identify the product with respect to a repository of information operably linked to the mobile computing device;
providing the captured product parameters to the repository of information;
providing location parameters of the mobile computing device to a market locator system;
receiving product information at the mobile device from the repository of information, the product information corresponding to the product parameters and being selected in accordance with a location of the mobile device identified by the market locator system; and
delivering the targeted product information to a display of the mobile device.

16. The method of claim 15, wherein the display of the mobile device provides a map noting the relative locations of merchants to the identified market location.

17. The method of claim 16, wherein the map includes pricing information for each merchant.

18. The method of claim 17, wherein the pricing information includes coupon data.

19. The method of claim 18, further comprising,
providing product information captured in the past to the repository of information in exchange for the coupon data.
